(19) United States
(12) Patent Application Publication
(10) Pub. No.: US 2008/0236855 A1
(43) Pub. Date: Oct. 2, 2008

(54) Electric Power Tool

(76) Inventors: Gerhard Meixner, Filderstadt (DE); Juergen Lennartz, Ostfidern (DE)

Correspondence Address: Michael J Striker;Striker, Striker & Stenby, 103 East Neck Road, Huntington, NY, 11743, US

(21) Appl. No.: 10/593,984

(22) PCT Filed: Mar. 17, 2006
(86) PCT No.: PCT/EP2006/060837

§ 371 Date: Sep. 25, 2006

(30) Foreign Application Priority Data
May 11, 2005 (DE) 10 2005 021 734.6

(51) Int. Cl. B25D 9/06; B25D 9/00

(52) U.S. Cl. 173/201; 173/206

(57) ABSTRACT

An electric power tool, in particular an electric hammer, having a drive unit (11) contained in a housing (10), an impact mechanism (12), and a handle (13), including a cam (14) that is driven by the drive unit (11); the impact mechanism (12) has moving parts (15, 16).

At least two of the moving parts (15, 16) are able to move inside a separate guide cylinder (17) that is stationary in relation to the moving parts (15, 16) and the cam (14).

### PRIOR ART

The present invention is based on an electric power tool according to the preamble to claim 1.

Know electric power tools, in particular power hammers, have a drive unit in the form of a wobble pin or connecting rod serving as a drive unit for a hammer piston. Drive units of this kind are known, for example, as crank drives, in which rotary movements of a drive unit, which are transmitted via a crankshaft, are converted into linear movements of the connecting rod. In this case, the drive unit and crankshaft are coupled to each other, in particular by means of a gearing in the form of a gear-tooth clutch. In rotary hammers and percussion hammers, the impact mechanism usually functions on the basis of piston or lever movements that are driven by the connecting rod.

There are also older known electric hammer designs that have a piston drive unit with a slider crank. Slider crank mechanisms are usually comprised of a crankshaft equipped with an eccentrically situated crank pin. The connecting rod is structurally integrated into a unit with a lifting rod. In order to convert the movement direction, a connection, which is situated between the crankshaft and the connecting rod and is embodied in the form of a crank pin, travels inside a so-called slider crank. In electric hammers of this kind, a pot-type piston, which can move back and forth and is connected to a cam, is used as an impact mechanism. A connecting link connected to the pot-type piston, the piston itself, and the tube in which the striker moves are embodied as integrally joined to one another. The quality of such electric hammers is not always satisfactory. The crank pin in particular is subjected to an unsatisfactory bearing friction because of the slider crank.

There are also known electric hammers with a pot-type piston impact mechanism, including a steel piston usually made of cast steel with a connecting link cast onto it. A movement conversion by means of the connecting link basically corresponds to that of the slider crank, but the design is less favorable. Primarily, the designer aspect of the known electric hammers is not taken into sufficient consideration.

### ADVANTAGES OF THE INVENTION

An electric power tool according to the present invention, in particular an electric hammer, includes a cam driven by a drive unit and an impact mechanism with moving parts; at least two of the moving parts are able to move inside a separate guide cylinder that is stationary in relation to the moving parts and the cam. In particular, a piston and a striker can be provided as the moving parts; the piston that can be moved by the drive unit is able to actuate the striker in a known fashion via an air cushion. The piston and striker can suitably have the same diameter. An electric hammer designed in such a way has a quality equivalent to the known electric hammers with different impact mechanisms.

Preferably, the piston is connected to the drive unit via a drive element. The embodiment according to the present invention advantageously permits the length of the electric power tool to be shortened. It is thus possible not only for a new designer aspect to be taken into consideration, but also primarily to achieve a slim contour of the electric power tool, as a result of which it is simultaneously also possible to shift the center of gravity and improve the safety of the unit's handling.

Preferably, the piston and the drive element are connected to each other by means of a pin. In a preferred embodiment form, a pin axis of the pin and the rotation axis of the drive unit can be oriented at an angle in relation to each other, for example of 90°. It is also possible for the piston and the drive element to be embodied as integrally joined to each other.

In a modification of the present invention, it is possible to adjust an angle between a longitudinal axis of the impact mechanism and a rotation axis of the drive unit. If the drive element is embodied in the form of a cranked rod, then it is advantageously possible to vary an angle between the longitudinal axis of the impact mechanism and the rotation axis of the drive unit. This permits achievement of a new designer-based construction. In addition, this permits an advantageous shifting of the center of gravity in that the drive unit is situated centrally in relation to a longitudinal span of the handle. This permits a reduction of a height of the unit, which has a favorable effect on the weight distribution in the unit and consequently on its handling. On the whole, the embodiment according to the present invention makes it possible to achieve an elongated, more symmetrical form in comparison to the known electric hammers.

In one embodiment form of the present invention, the drive element can be at least partially comprised of plastic. This advantageously permits a lightweight construction, which in turn makes a positive contribution to an easier, safe operability.

In order to transmit force between the cam and the drive element, it is possible for a slider crank to be provided. In an above-described cranked embodiment form of the drive element, the slider crank is laterally offset in relation to a longitudinal span of the drive element, which in turn permits advantageous variations in the construction of the unit, making use of new designer aspects. If the slider crank is made of plastic, then it is advantageously possible to prevent a premature deflection of the slider crank due to the above-explained high friction forces. This results in a longer service life of the slider crank and thus represents an advantageous cost savings. To further avoid premature wear, a ball is able to move inside the slider crank.

It is also possible for a connecting link to be provided for the transmission of force between the cam and the drive element. It is possible for a sliding block to be provided between the eccentric pin and the connecting link, thus advantageously preventing or reducing an undesirable friction. In lieu of the sliding block, it is also possible to embody a different intermediate element that functions in the same manner. The connecting link is preferably embodied as straight. It can, however, also have a different form.

In an alternative embodiment form, the impact mechanism is embodied with a pot-type striker. Alternatively, an impact mechanism can be embodied with a pot-type piston, which is able to activate a pot-type striker. To reduce the weight of the structure, the pot-type piston is preferably comprised of a light alloy. Alternatively, the pot-type piston can also be made of plastic or of a light alloy/plastic composite. This material composition gives the unit a particularly long service life.

### DRAWINGS

Other embodiment forms, aspects, and advantages of the present invention ensue from the following exemplary embodiments of the invention shown in the drawings, independent of their combination in the claims and without limitation as to their universal applicability.

FIG. 1 is a schematic section through one embodiment form of an electric power tool according to the present invention;

FIG. 2 is a schematic top view of an alternative embodiment form; and

FIG. 3 is a schematic section through another alternative embodiment form.

### DESCRIPTION OF THE EXEMPLARY EMBODIMENTS

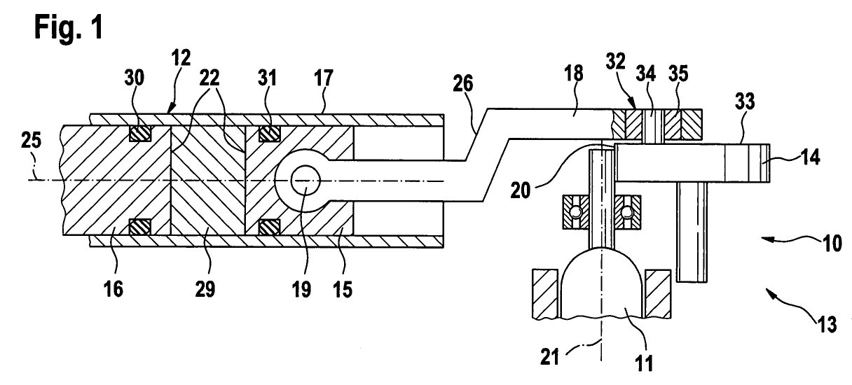

FIG. 1 is a longitudinal section through an electric hammer, having a drive unit 11 contained in a housing 10, an impact mechanism 12, and a handle 13. The drive unit 11 drives a cam 14; the drive unit 10 and the cam 14 are coupled to each other in a known manner by means of a gearing in the form of a gear-teeth clutch 20. In order to transmit force between the cam 14 and the drive element 18, a connecting link 32 is provided. The rotary motion that the drive unit 11 transmits to the cam 14 is converted by the connecting link 32 into a linear stroke motion of the drive element 18 and is transmitted to an impact mechanism 12.

The impact mechanism 12 includes two moving parts embodied in the form of a piston 15 and a striker 16, which are able to move inside a separate guide cylinder 17 that is stationary in relation to the moving parts 15, 16. The piston 15 and the striker 16 have the same diameter 22. An annular seal 30 is provided between the piston 15 and the guide cylinder 17 and an annular seal 31 is provided between the striker 16 and the guide cylinder 17. The piston 15 is connected to the drive unit 11 via the drive element 18. The drive element 18 is embodied as a cranked rod with a cranked section 26. The longitudinal segments of the drive element 18 before and after the cranked section 26 are offset from and parallel to each other. The connecting link 32 connected to a free end of the drive element 18 is thus laterally offset from the pin 19 situated at other free end of the drive element 18. An upper edge of the drive element 18 ends in this region, approximately at an upper edge of the guide cylinder 17. This makes it possible to reduce the length of the electric hammer in the region of the handle 13. The drive element 18 is at least partially comprised of plastic.

The drive element 18 and the piston 15 are connected to each other by means of a pin 19. A pin axis of the pin 19, which extends transversely to the plane of the drawing, and a rotation axis 21 of the drive unit 11 are oriented at an angle of 90° in relation to each other. The linear stroke motion of the drive element 18 generates a compression and a vacuum against the piston, which accelerate the striker 16 via an air cushion 29. The striker 16 imparts its energy to an insert tool that is now shown.

The cam 14 has a cam disk 33, which is connected to the drive element 18 via an eccentric pin 34. The eccentric pin 34 is inserted into a sliding block 35 in order to minimize a friction between the eccentric pin 34 and the connecting link 32. The sliding block 35 functions inside the connecting link 32 of the drive element 18. The connecting link 32 is straight. The linear stroke motion of the drive element 18, which is converted by the connecting link 32, has a sinusoidal curve with a straight connecting link 32. It is also possible for the connecting link 32 to be embodied in a different form, which correspondingly changes the curve of the longitudinal movement. This alternative is not shown in FIG. 1.

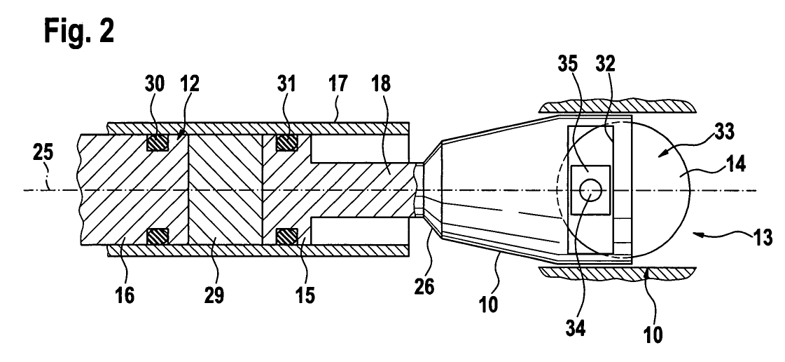

FIG. 2 is a top view of an alternative embodiment form in which the design and function of the individual components corresponds to those in FIG. 1. Elements that are the same have been labeled with the same reference numerals. By contrast with FIG. 1, the drive element 18 and piston 15 are not connected to each other by means of a pin 19, but are instead embodied as integrally joined to each other. This eliminates the need for a longitudinal guide. As opposed to FIG. 1 in which the piston is cylindrical, the piston 15 in FIG. 2 is disk-shaped. The disk-shaped piston 15 also has an annular seal 31 along its outer circumference.

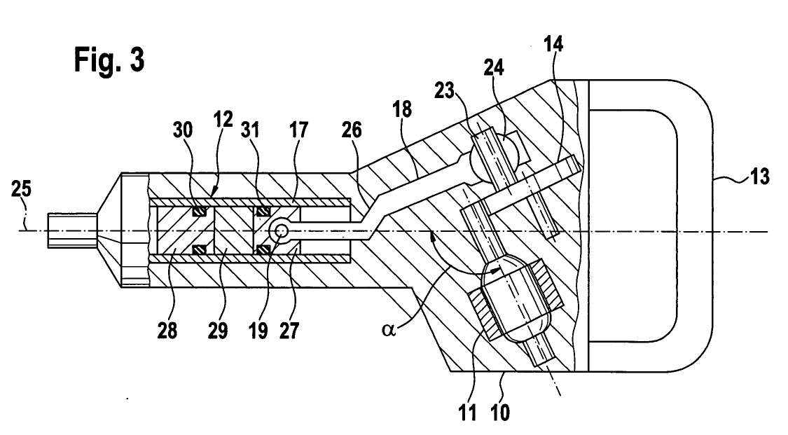

FIG. 3 shows another alternative embodiment form of an electric hammer according to the present invention, whose design essentially corresponds to the one in FIG. 1, with a cylindrical piston 15 that is connected by means of a pin 19 to a drive element 18 embodied in the form of a cranked rod. The impact mechanism 12 is embodied as a pot-type piston 27; the pot-type piston 27 actuates a pot-type striker 28. A slider crank 23 is provided to transmit the force between the cam 14 and the drive element 18. A ball 24 can move inside the slider crank 23.

By contrast with FIG. 1, the drive element 18 is embodied so that its longitudinal segments before and after the cranked section 26 are not parallel to each other; instead, the drive element 18 bends toward the cam 14. As a result, an angle α that is greater than 90° is formed between a longitudinal axis 25 of the guide cylinder 17 and a rotation axis 21 of the drive unit 11. It is thus possible to adjust the angle α by means of the cranked section 26 of the drive element. With the proposed arrangement, it is possible to vary the angle α between the impact mechanism 12 and the rotation axis 21 of the drive unit 11. This advantageously makes it possible to achieve a central placement of the drive unit 11 in relation to a longitudinal span of the handle 13. It is simultaneously possible to reduce a height of the electric hammer, particularly in the region of the handle 13.

This favorably affects a weight distribution in the unit, which is thus easier to maneuver. The present invention therefore achieves an advantageous, symmetrical, elongated structure. This makes it possible to achieve new designer embodiments.

What is claimed is:

1. An electric power tool, in particular an electric hammer, having a drive unit (11) contained in a housing (10), an impact mechanism (12), and a handle (13), including a cam (14) that is driven by the drive unit (11); the impact mechanism (12) has moving parts (15, 16),
wherein at least two of the moving parts (15, 16) are able to move inside a separate guide cylinder (17) that is stationary in relation to the moving parts (15, 16) and the cam (14).

2. The electric power tool as recited in claim 1, wherein a piston (15) and a striker (16) are provided as the moving parts.

3. The electric power tool as recited in claim 1, wherein the piston (15) is connected to the drive unit (11) by means of a drive element (18) embodied as a separate component.

4. The electric power tool as recited in claim 3, wherein the drive element (18) is embodied as a cranked rod.

5. The electric power tool as recited in claim 2,
wherein the piston (15) and the drive element (18) are connected to each other by means of a pin (19).

6. The electric power tool as recited in claim 5,
wherein a pin axis of the pin (19) and a rotation axis (21) of the drive unit (11) are oriented at an angle to each other.

7. The electric power tool as recited in claim 1,
wherein the piston (15) and the drive element (18) are embodied as integrally joined to each other.

8. The electric power tool as recited in claim 3,
wherein the drive element (18) is at least partially comprised of plastic.

9. The electric power tool as recited in claim 1,
wherein the piston (15) and the striker (16) have the same diameter (22).

10. The electric power tool as recited in claim 1,
wherein a slider crank (23) is provided to transmit the force between the cam (14) and the drive element (18).

11. The electric power tool as recited in claim 10,
wherein a ball (24) is able to move inside the slider crank (23).

12. The electric power tool as recited in
wherein it is possible to adjust an angle (α) between a longitudinal axis (25) of the guide cylinder (17) and a rotation axis (21) of the drive unit (11).

13. The electric power tool as recited in claim 12, wherein it is possible to adjust the angle (α) by means of a cranked section (26) of the drive element (18).

14. The electric power tool as recited in claim 1,
wherein the drive unit (11) is situated centrally in relation to a longitudinal span of the handle (13).

15. The electric power tool as recited in claim 1,
wherein the impact mechanism (12) is embodied as a pot-type piston (27) and the pot-type piston (27) is able actuate a pot-type striker (28).

16. The electric power tool as recited in claim 15,
wherein the pot-type piston (28) is comprised of light alloy.
